(19) United States
(12) Patent Application Publication
(10) Pub. No.: US 2022/0014062 A1
(43) Pub. Date: Jan. 13, 2022

(54) ELECTRIC MACHINE

(71) Applicant: Mahle International GmbH, Stuttgart (DE)

(72) Inventors: Roberto Almeida E Silva, Stuttgart (DE); Bernd Blankenbach, Boeblingen (DE); Terry Cox, Swinford, Leicestershire (GB); Philip Grabherr, Stuttgart (DE); Niklas Kull, Stuttgart (DE); Tim Male, Telford West Midlands (GB); Peter Pisek, Leitring (AT); Peter Sever, Murska Sobota (SI); Josef Sonntag, Nuertingen (DE); Martin Williams, Northkampton Northamptonshire (GB)

(21) Appl. No.: 17/295,328

(22) PCT Filed: Nov. 15, 2019
(86) PCT No.: PCT/EP2019/081478

§ 371 Date: May 19, 2021

(30) Foreign Application Priority Data
Nov. 19, 2018 (DE) 10 2018 219 816.0

(51) Int. Cl. H02K 3/24; H02K 3/34; H02K 9/19; H02K 9/22; H02K 5/128

(52) U.S. Cl. CPC H02K 3/24; H02K 3/345; H02K 5/128; H02K 9/22; H02K 9/19

(57) ABSTRACT

An electric machine may include a rotor and at least one cooling channel. The rotor may be rotatable about an axis defining an axial direction and include a stator having electrically conductive stator windings. A coolant may flow through the at least one cooling channel to the cool the stator windings. The stator may include teeth extending along the axial direction. The at least one cooling channel and the stator windings may be arranged in at least one intermediate space formed between two adjacent stator teeth. A plastic for transmitting heat from the stator windings to the at least one cooling channel may be arranged in the intermediate space.

### CROSS-REFERENCE TO RELATED APPLICATIONS

This application claims priority to International Patent Application No. PCT/EP2019/081478, filed on Nov. 15, 2019, which also claims priority to German Patent Application DE 10 2018 219 816.0 filed on Nov. 19, 2018, each of which is hereby incorporated by reference in its entirety.

### TECHNICAL FIELD

The invention relates to an electric machine, in particular for a vehicle, and to a vehicle comprising such a machine.

An electric machine of this type can in general be an electric motor or a generator. The electric machine can be in the form of an external rotor or an internal rotor.

### BACKGROUND

A machine of the type in question is known, for example, from U.S. Pat. No. 5,214,325. It comprises a housing which surrounds an interior space and which has a casing encircling in a circumferential direction of the housing and radially bounding the interior space, a rear side wall axially bounding the interior space axially on one side and a front side wall axially bounding the interior space axially on the other side. A stator of the machine is fixedly connected to the casing. A rotor of the machine is arranged in the stator, with a rotor shaft of the rotor being mounted rotatably on the front side wall via a front shaft bearing.

The stator of a conventional electric machine typically comprises stator windings which are electrically energized during the operation of the machine. In the process, heat arises which has to be dissipated in order to avoid overheating and associated damage or even destruction of the stator. For this purpose, it is known from conventional electric machines to equip said machines with a cooling device for cooling the stator—in particular said stator windings. Such a cooling device comprises one or more cooling channels through which a coolant flows and which are arranged in the vicinity of the stator windings in the stator. Heat can be dissipated from the stator by transmission of heat from the stator windings to the coolant.

It has proven disadvantageous here that efficient transfer of heat from the stator to the coolant flowing through the respective cooling channel is associated only with a considerable structural outlay. However, this has a disadvantageous effect on the production costs of the electric machine.

### SUMMARY

It is therefore an object of the present invention to provide an improved embodiment for an electric machine, in which said disadvantage is substantially or even completely eliminated. In particular, the intention is to provide an improved embodiment for an electric machine that is distinguished by improved cooling of the stator windings of the stator.

This object is achieved by the subject matter of the independent patent claims. Preferred embodiments are the subject matter of the dependent patent claims.

Accordingly, the basic concept of the invention is to embed the stator windings of an electric machine together with a cooling channel through which a coolant flows and which is provided for cooling the stator windings into a plastic which typically combines electrically insulating and heat-conducting properties. The plastic can therefore act firstly as a heat-transmitting medium for transmitting heat from the stator windings to the coolant flowing through the cooling channel and secondly as an electrical insulator for the stator windings. In particular, particularly good transfer of heat between the stator windings and the coolant guided through the cooling channel is thereby produced. This is true in particular if use is made of a plastic which has high thermal conductivity. Use of a plastic with electrically insulating properties additionally ensures that the stator windings to be cooled by the electric plastic are not undesirably electrically short-circuited by the plastic guided through the cooling channel. In addition, it is ensured that the—typically electrically conductive coolant—when the latter flows through the cooling channel, is electrically insulated from the cooling channel of the stator windings. Furthermore, the stator teeth as part of the stator can also be electrically insulated from the stator windings by means of the plastic.

The direct thermal coupling of the cooling channel with the coolant to the stator windings to be cooled, with the aid of the plastic essential to the invention, leads to particularly effective cooling of the stator windings in comparison to conventional cooling devices. Even when a high level of raised heat is produced in the stator, as occurs, for example, in a high-load mode of the electric machine, it can therefore be ensured that the waste heat which arises can be dissipated from the stator. Damage or even destruction of the electric machine due to overheating of the stator can therefore be avoided.

An electric machine according to the invention, in particular for a vehicle, comprises a rotor which is rotatable about an axis of rotation which defines an axial direction of the electric machine. Furthermore, the machine comprises a stator which has electrically conductive stator windings, and at least one cooling channel through which a coolant can flow, for cooling the stator winding. The stator has stator teeth which extend along the axial direction, are arranged at a distance from one another along a circumferential direction of the rotor and carry the stator winding. At least one cooling channel and at least one stator winding are arranged in at least one intermediate space which is formed between two adjacent stator teeth in the circumferential direction. According to the invention, a plastic for transmitting heat from the stator winding to the cooling channel is arranged in the intermediate space.

The plastic is preferably therefore heat-conducting. The plastic can expediently also be electrically insulating, i.e. can be composed of an electrically insulating plastics material.

According to a preferred embodiment, the plastic is at least partially arranged on the surface portions of the two adjacent stator teeth bounding the intermediate space. The cooling channel and the stator winding are preferably in each case electrically insulated from the stator teeth and connected in a heat-conducting manner to each other by means of the plastic.

According to another further preferred embodiment, the stator comprises a stator body from which the stator teeth protrude radially inward. In this embodiment, which in particular can be combined with the above-explained embodiment, the plastic is arranged on a surface portion of the stator body that bounds the intermediate space radially on the outside.

The plastic is particularly preferably arranged here on all surface portions of the two stator teeth that bound the intermediate space, i.e. both to the circumferential-side and also radial boundary of the relevant intermediate space. This makes it possible to prevent an undesired electrical connection from being able to arise between the electrically conductive material of the stator windings and the likewise electrically conductive stator teeth.

According to an advantageous development, the plastic arranged on the surface portions forms an electrically insulating insulation layer which covers the surface portions of the two adjacent stator teeth bounding the intermediate space. Such an insulation layer made from plastic can be produced particularly simply, for example by means of an injection molding process.

The cooling channel is expediently arranged in the region of a radially inner end portion of the intermediate space. A particularly large amount of construction space for the arrangement of the stator winding(s) in the intermediate space is thereby available. Alternatively or additionally, the arrangement of a cooling channel in the region of a radially outer end portion of the intermediate space is conceivable.

In a further preferred embodiment, the plastic forms at least one phase insulation which is arranged in the intermediate space and divides the intermediate space into a radially inner and a radially outer partial space. Conductor elements of the stator winding that are electrically insulated from one another can thereby be arranged in the two partial spaces. This in turn makes it possible to assign two different electrical phases that have to be electrically separated from each other to the two conductor elements which are electrically insulated from each other. In a development of the invention, it is conceivable for a plurality of such phase insulations to also be provided in an intermediate space. A diameter, measured in the radial direction, of the phase insulation made from the plastic is expediently between 1 mm and 3 mm.

The phase insulation can expediently extend along the circumferential direction and can thus connect the two insulation layers which are arranged on the adjacent stator teeth and are made from plastic to each other. The two partial spaces which are formed are thereby completely bounded by the, preferably electrically insulating, plastic.

According to an advantageous development, the at least one stator winding arranged in the intermediate space comprises at least one first conductor element and at least one second conductor element. According to this development, these two conductor elements are arranged at a distance from each other in the intermediate space, specifically preferably along the radial direction. The first conductor element can be part of a first electrical phase, and the second conductor element can correspondingly be part of a second electrical phase of the stator. Expediently, the first conductor elements are arranged in the radially inner partial space and are connected electrically to one another for the connection to a common first phase of an electrical power source. In this embodiment, the two conductor elements are arranged in the radially outer partial space and are electrically connected to one another for the connection to a common second phase of the electric power source.

At least one first and, alternatively or additionally, one second conductor element is expediently surrounded by the electrically insulating and heat-conducting plastic that is essential to the invention in the cross section perpendicular to the axial direction. This preferably applies to all of the first and, alternatively or additionally, to all of the second conductor elements.

The first and, alternatively or additionally, the second conductor elements can be particularly expediently formed as winding bars made from an electrically conductive material.

According to an advantageous development, at least one winding bar can have the geometry of a rectangle with two narrow sides and with two wide sides in the cross section perpendicular to the axial direction. This preferably applies to all of the winding bars of the stator winding.

According to a particularly preferred embodiment, the at least one first conductor element is electrically insulated from the at least one second conductor element by means of the plastic. The first conductor elements are particularly preferably electrically insulated from the second conductor elements by means of the phase insulation which separates the radially inner partial space from the radially outer partial space.

In a further preferred embodiment, the plastic, in the cross section perpendicular to the axial direction, forms a protective coating which is arranged in the intermediate space and at least partially, preferably completely, bounds or encases the cooling channel. “Boundary” means in particular that the cooling channel does not require a further boundary, for example in the form of a tubular body. “Protective coating” means in particular that an additional boundary, for example in the form of said tubular body, can be provided for the cooling channel. It can be prevented by means of the protective coating that the coolant which is guided through the cooling channel and which is typically electrically conductive can enter into contact with the stator winding, likewise arranged in the intermediate space, or the electrically conductive stator teeth such that an electrical short-circuit occurs.

According to an advantageous development, the protective coating, in the cross section perpendicular to the axial direction, bounds the cooling channel radially on the inside and, alternatively or additionally, radially on the outside. This provides electrical insulation of the cooling channel or of the coolant guided through the cooling channel from the stator windings arranged in the intermediate space radially outside or radially inside the cooling channel.

According to a further advantageous development, which can be combined with the above-explained development, the protective coating, in the cross section perpendicular to the axial direction, bounds the cooling channel in the circumferential direction. This ensures the electrical insulation of the cooling channel or of the coolant guided through the cooling channel from the electrically conductive stator teeth.

Particularly expediently, a further cooling channel can be arranged, in particular in the region of a radially outer end portion of the intermediate space. The cooling of the stator winding(s) can thereby be significantly improved.

In another preferred embodiment, the plastic forms a further protective coating which is arranged in the intermediate space and which at least partially, preferably completely, bounds or encases the further cooling channel.

According to a further advantageous development, the further protective coating, in the cross section perpendicular to the axial direction, bounds the further cooling channel radially on the inside and, alternatively or additionally, radially on the outside. With the further protective coating, electrical insulation of the further cooling channel or of the coolant guided through the further cooling channel from the stator windings arranged radially outside or radially inside the further cooling channel in the intermediate space is ensured.

According to a further advantageous development, which can be combined with the above-explained development, the further protective coating bounds the further cooling channel in the circumferential direction in the cross section perpendicular to the axial direction. This ensures the electrical insulation of the further cooling channel or of the coolant guided through the further cooling channel from the electrically conductive stator teeth.

Expediently, the cooling channel arranged in the region of the radially inner end portion is arranged in the radially inner partial space formed by means of the phase insulation of plastic. Alternatively or additionally, the cooling channel arranged in the region of the radially outer end portion is arranged in the radially outer partial space formed by means of the phase insulation from plastic. In this manner, conductor elements of the stator winding(s) arranged both radially on the inside and radially on the outside in the intermediate space can be highly effectively cooled by heat transmission to the coolant guided through the respective cooling channel.

According to another preferred embodiment, a gap is formed at least in sections between at least two conductor elements and, alternatively or additionally, between at least one conductor element and the electric insulation layer arranged on the surface portions of the stator teeth and/or of the stator body. In this embodiment, the plastic essential to the invention forms a gap filling with which the gap is at least partially, preferably completely, filled.

According to another preferred embodiment, the plastic can comprise an electrically insulating plastics mass in which the stator winding is embedded.

The intermediate space can expediently have the geometry of a trapezoid, preferably a rectangle, in the cross section perpendicular to the axial direction. The geometry of a trapezoid or rectangle permits both at least one cooling channel and a large number of conductor elements and/or stator windings to be arranged in the respective intermediate space.

According to a preferred embodiment, the plastic provided on the surface portions of the stator teeth is formed by an electrically insulating first plastics material. Alternatively or additionally, in this embodiment, the plastic forming the at least one phase insulation is formed by a second plastics material. Furthermore, the plastic forming the first protective coating and, alternatively or additionally, the plastic forming the further protective coating can be formed by the second plastics material or, alternatively thereto, by a third plastics material.

According to an advantageous development, the first and, alternatively or additionally, the second and, alternatively or additionally, the third plastics material are identical materials. In an alternative development thereto, the first and, alternatively or additionally, the second and, alternatively or additionally, the third plastics material can be different materials.

Expediently, the first and, alternatively or additionally, the second and, alternatively or additionally, the third plastics material can consist of a thermoplastic or can comprise such a thermoplastic. Similarly expediently, the first and, alternatively or additionally, the second and, alternatively or additionally, the third plastics material can consist of a thermosetting plastic or can comprise a thermosetting plastic.

Expediently, the first and, alternatively or additionally, the second and, alternatively or additionally, the third plastics material have identical heat conductivities. Alternatively or additionally, the first and, alternatively or additionally, the second and, alternatively or additionally, the third plastics material can have different heat conductivities.

Expediently, the first and, alternatively or additionally, the second and, alternatively or additionally, the third plastics material can be identical materials. Similarly, the first and, alternatively or additionally, the second and, alternatively or additionally, the third plastics material can also, however, be different materials.

According to a particularly preferred embodiment, the at least one stator winding is part of a distributed winding.

According to a preferred embodiment, the heat conductivity of the plastic, in particular of the first and, alternatively or additionally, of the second and, alternatively or additionally, of the third plastics material is at least 0.5 W/mK, preferably at least 1 W/mK.

In a further preferred embodiment, the intermediate space is formed by means of the plastic so as to be substantially free of gaps.

In an embodiment which is particularly simple to realize, only a single, i.e. not a second, cooling channel is provided in the intermediate space.

According to an advantageous development, the machine comprises a coolant distributor space and a coolant collector space arranged axially at a distance from the latter. The coolant distributor space communicates here fluidically with the coolant collector space by means of the at least one cooling channel through which a coolant can flow. A plurality of such cooling channels are preferably provided between the coolant distributor space and the coolant collector space.

According to a preferred embodiment, the coolant distributor space and, alternatively or additionally, the coolant collector space, for the thermal coupling to the stator windings, are at least partially arranged in the plastic which is essential to the invention and which in this case consists of an electrically insulating plastics material. This permits a particularly good transfer of heat between the coolant distributor space and/or coolant collector space and the stator windings such that the coolant distributor space and/or the coolant collector space can also be used for directly absorbing heat from the stator windings.

The electrically insulating plastic particularly preferably at least partially bounds the coolant distributor space and, alternatively or additionally, the coolant collector space, for the thermal coupling to the stator windings.

The invention furthermore relates to a vehicle, in particular a motor vehicle, comprising an electric machine presented above. The above-explained advantages of the electric machine therefore also apply to the vehicle according to the invention.

Further important features and advantages of the invention emerge from the dependent claims, from the drawings and from the associated description of the figures with reference to the drawings.

It goes without saying that the features mentioned above and those which have yet to be explained below can be used not only in the respectively stated combination, but also in different combinations or on their own without departing from the scope of the present invention.

Preferred exemplary embodiments of the invention are illustrated in the drawings and will be explained in more detail in the description below.

### BRIEF DESCRIPTION OF THE DRAWINGS

In the drawings, in each case schematically:

FIG. 1 shows an example of an electric machine according to the invention in a longitudinal section along the axis of rotation of the rotor,

FIG. 2 shows the stator of the electric machine according to FIG. 1 in a cross section perpendicular to the axis of rotation of the rotor,

FIG. 3 shows a detailed illustration of the stator of FIG. 2 in the region of an intermediate space between two adjacent stator teeth in the circumferential direction,

FIG. 4 shows a development of the example according to FIG. 3 with an additional second cooling channel,

FIG. 5 shows a variant of the example according to FIG. 3, in which the stator windings are not formed by winding bars, but rather by winding wires formed in a plastics compound.

### DETAILED DESCRIPTION

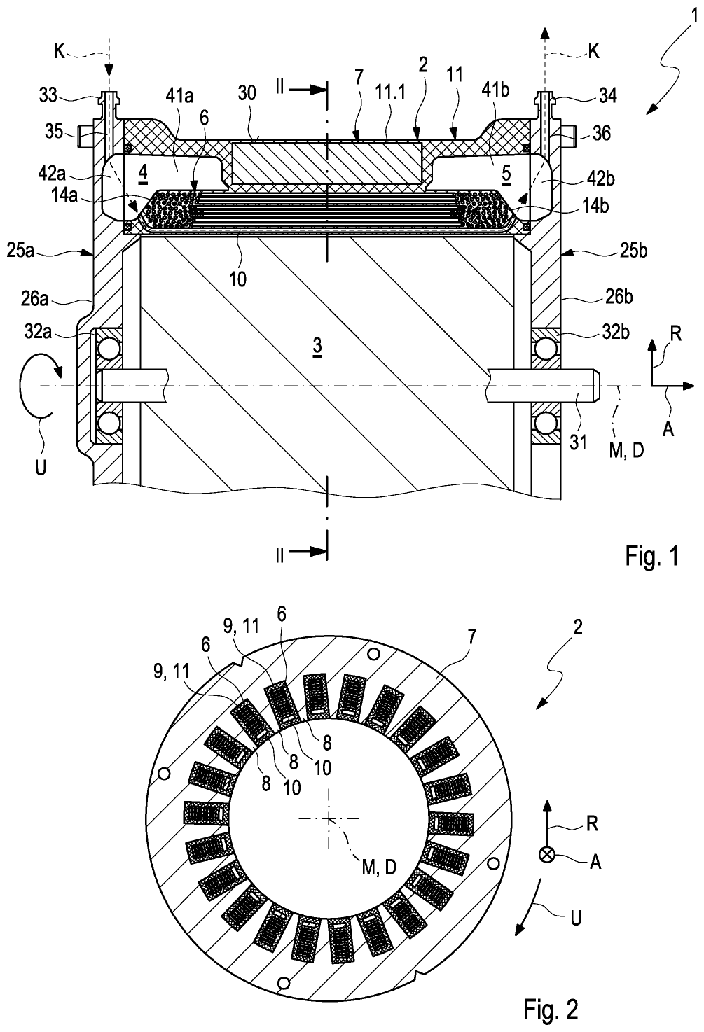

FIG. 1 illustrates an example of an electric machine 1 according to the invention in a sectional illustration. The electric machine 1 is dimensioned in such a manner that it can be used in a vehicle, preferably in a road vehicle.

The electric machine 1 comprises a rotor 3, illustrated only roughly schematically in FIG. 1, and a stator 2. For clarification, the stator 2 in FIG. 2 is illustrated in a separate illustration in a cross section perpendicular to the axis of rotation D along the intersecting line II-II from FIG. 1. According to FIG. 1, the rotor 3 has a rotor shaft 31 and can have a plurality of magnets, not illustrated specifically in FIG. 1, the magnetic polarizations of which change along the circumferential direction U. The rotor 3 is rotatable about an axis of rotation D, the position of which is defined by the center longitudinal axis M of the rotor shaft 31. The axis of rotation D defines an axial direction A which extends parallel to the axis of rotation D. A radial direction R is perpendicular to the axial direction A. A circumferential direction U rotates about the axis of rotation D.

As FIG. 1 reveals, the rotor 3 is arranged in the stator 2. The electric machine 1 shown here is therefore what is referred to as an internal rotor. However, a realization in the form of what is referred to as an external rotor, in which the rotor 3 is arranged outside the stator 2, is also conceivable. The rotor shaft 31 is mounted on the stator 2 rotatably about the axis of rotation D in a first shaft bearing 32a and, spaced apart axially therefrom, in a second shaft bearing 32b.

In addition, the stator 2 comprises in a known manner a plurality of stator windings 6 which can be electrically energized in order to generate a magnetic field. The rotor 3 is set into rotation by magnetic interaction of the magnetic field generated by the magnets of the rotor 3 with the magnetic field generated by the electrically conductive stator windings 6.

It is gathered from the cross section of FIG. 2 that the stator 2 can have an annular stator body 7, for example made of iron. In particular, the stator body 7 can be formed from a plurality of stator body plates (not shown) which are stacked one on another along the axial direction A and are adhesively bonded to one another. A plurality of stator teeth 8 are integrally formed radially on the inside of the stator body 7, the stator teeth extending along the axial direction A, protruding away radially inward from the stator body 7 and being spaced apart from one another along the circumferential direction U. Each stator tooth 8 carries a stator winding 6. The individual stator windings 6 together form a winding arrangement. Depending on the number of magnetic poles to be formed by the stator windings 6, the individual stator windings 6 of the entire winding arrangement can be electrically wired to one another in a suitable manner.

During the operation of the machine 1, the electrically energized stator windings 6 generate waste heat which has to be dissipated from the machine 1 in order to prevent overheating and associated damage or even destruction of the machine 1. The stator windings 6 are therefore cooled with the aid of a coolant K which is guided through the stator 2 and which, by transmission of heat, absorbs waste heat generated by the stator windings 6.

In order to guide the coolant K through the stator 2, the machine 1 comprises a coolant distributor chamber 4 into which a coolant K can be introduced via a coolant inlet 33. A coolant collector chamber 5 is arranged along the axial direction A at a distance from the coolant distributor chamber 4. The coolant distributor chamber 4 communicates fluidically with the coolant collector chamber 5 by means of a plurality of cooling channels 10, of which only a single one can be seen in the illustration of FIG. 1. The coolant distributor chamber 4 and the coolant collector chamber 5 can each have an annular geometry in a cross section, not shown in the figures, perpendicular to the axial direction A. A plurality of cooling channels 10 are arranged spaced apart from one another along the circumferential direction U and each extend along the axial direction A from the annular coolant distributor chamber 4 to the annular coolant collector chamber 5. The coolant K introduced into the coolant distributor chamber 4 via the coolant inlet 33 can therefore be distributed to the individual cooling channels 10. After flowing through the cooling channels 10 and absorbing heat from the stator windings 6, the coolant K is collected in the coolant collector chamber 5 and is discharged again from the machine 1 via a coolant outlet 34 provided on the stator 2.

As can be seen in the illustrations of FIGS. 1 and 2, the stator windings 6 and the cooling channels 10 are arranged in intermediate spaces 9 which are formed between in each case two adjacent stator teeth 8 in the circumferential direction U. Said intermediate spaces 9 are also known to a relevant person skilled in the art as “stator grooves” or “stator slots” which, like the stator teeth 8, extend along the axial direction A.

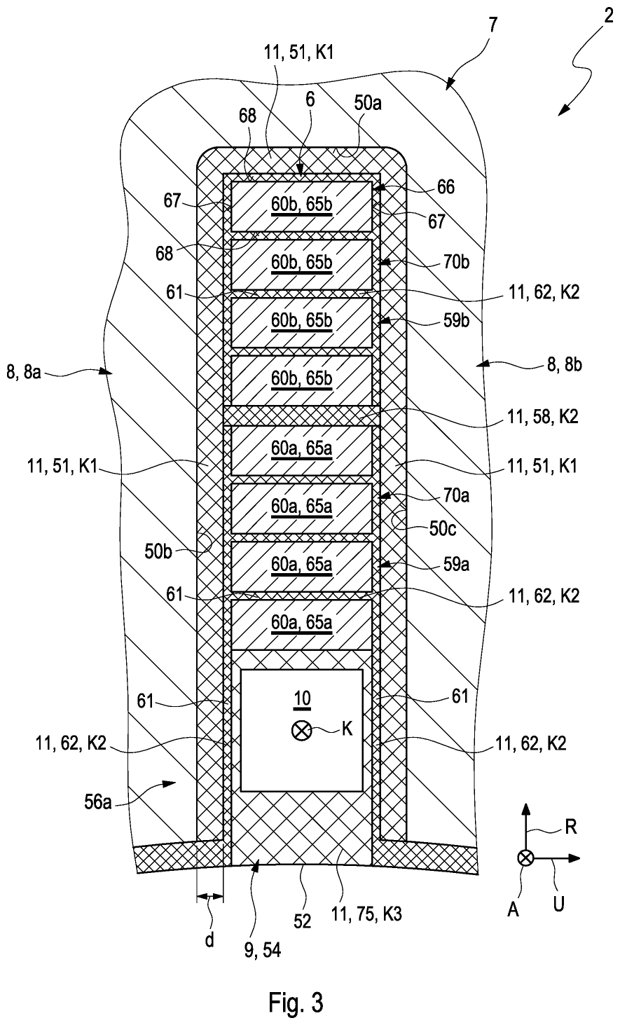

The illustration of FIG. 3 which shows an intermediate space 9 formed between two adjacent stator teeth 8 in the circumferential direction U—also referred to below as stator teeth 8a, 8b—in a detailed illustration, will be explained below.

As FIG. 3 shows, the intermediate space 9 has an opening 52 radially on the inside, i.e. is open radially on the inside. The intermediate space 9 can have the geometry of a trapezoid, in particular a rectangle, in the cross section perpendicular to the axial direction A. In the example of FIG. 3, the cooling channel 10 is arranged in the region of a radially inner end portion 56a of the intermediate space 9 or of the stator groove 54, i.e. in the region of the opening 52.

In order to improve the transmission of heat of the waste heat generated by the stator windings 6 to the coolant K flowing through the cooling channels 10, a heat-conductive plastic 11 is additionally arranged in the intermediate spaces 9 next to a cooling channel 10 and a stator winding 6 according to FIG. 3. Said plastic 11 is preferably introduced into the intermediate space 9 by injection molding.

As FIG. 3 reveals, the plastic 11 is arranged on surface portions 50b, 50c of two stator teeth 8 which are adjacent in the circumferential direction U and bound the intermediate space 9. Furthermore, the plastic 11 is arranged on a surface portion 50a of the stator body 7 that bounds the intermediate space 9 radially on the outside.

The plastic 11 arranged on the surface portions 50a, 50b, 50c is expediently an electrically insulating plastic. It is therefore ensured that both the cooling channel 10 arranged in the intermediate space 9 and the stator winding 6 arranged in the same intermediate space 9 are in each case electrically insulated from the stator teeth 8 by means of the plastic 11. Furthermore, the stator winding 6 is connected in a heat-conducting manner to the cooling channel 10 via the plastic 11 such that waste heat generated in or by the stator winding 6 can be transmitted via the plastic 11 to the coolant K flowing through the cooling channel 10 and can thus be removed from the stator winding 6.

The plastic 11 arranged on the three surface portions 50a, 50b, 50c forms an electrically insulating and heat-conducting insulation layer 51 which covers the surface portions 50a, 50b, 50c. For example, a layer thickness d of the insulation layer 51 can be between 0.2 mm and 0.5 mm.

According to FIG. 3, the plastic 11 can not only form the insulation layer 51 but—alternatively or additionally thereto—also a phase insulation 58 arranged in the intermediate space 9 or in the stator groove 54. The phase insulation 58 divides the intermediate space 9 into a radially inner and into a radially outer partial space 59a, 59b. First conductor elements 60a of the stator winding 6, which conductor elements form a first phase winding 70a, can thus be arranged in the radially inner partial space 59a. Similarly, second conductor elements 60b of the stator winding 6, which form a second phase winding 70b that is electrically insulated from the first phase winding 70a, can be arranged in the radially outer partial space 59b.

The phase insulation 58 expediently extends along the circumferential direction U. The phase insulation 58 preferably connects the two insulation layers 51 which are arranged on the adjacent stator teeth 8a, 8b and are made from the plastic 11 to each other.

It is seen that the plastic 11 not only forms the electric insulation layer 51, but also a first protective coating 75 which is arranged in the intermediate space 9 and bounds or surrounds the cooling channel 10. The provision of a tubular body or the like for the fluid-tight boundary of the cooling channel 10 in such a manner that no coolant K can emerge therefrom is thus superfluous.

In the example scenario of FIG. 3, the first protective coating 75 closes the opening 52 of the open intermediate space 9 or of the stator groove 54.

As FIG. 3 furthermore reveals, the stator winding 6 is not only electrically insulated from the cooling channel 10 via the plastic 11 forming the first protective coating 75, but is also connected in a heat-conducting manner to said cooling channel such that waste heat generated in or by the stator winding 6 can also be transmitted via the first protective coating 75 to the coolant K flowing through the cooling channel 10.

The first conductor elements 60a are arranged in the radially inner partial space 59a and the second conductor elements 60b in the radially outer partial space 59b.

The cooling channel 10 arranged in the region of the radially inner end portion 54a is arranged in the radially inner partial space 59a formed by means of the phase insulation 58 made from plastic 11.

As FIG. 3 reveals, the stator winding 6 arranged in the intermediate space 9 comprises first conductor elements 60a and second conductor elements 60b which are arranged next to one another along the radial direction R and at a distance from one another in the intermediate space 9. A gap 61 is formed between in each case two conductor elements 60a, 60b which are adjacent along the radial direction R, said gap preferably being able to extend along the circumferential direction U. The plastic 11 forms a gap filling 62 with which the gap 61 is completely filled.

In a similar manner, a gap 61 can be formed between the first and second conductor elements 60a, 60b and the electrical insulation arranged on the surface portions 50b, 50c of the stator teeth 8a, 8b. Also in this case, the plastic 11 forms a gap filling 62 by means of which the gap 61 is filled. It goes without saying that said gap 61 which is filled with the plastic 11 can also extend only in sections or can be present in the form of what is referred to as an air inclusion. It is also conceivable for there to be a plurality of gaps 61 or air inclusions which are filled with the gap filling 62 consisting of the plastic 11. All the first and second conductor elements 60a, 60b are thus surrounded by the electrically insulating and heat-conducting plastic 11 in the cross section perpendicular to the axial direction A, as illustrated in FIG. 3.

The first and second conductor elements 60a, 60b are in each case formed as first or second winding bars 65a, 65b from an electrically conductive and mechanically stiff material. In the cross section perpendicular to the axial direction A, the first and second winding bars 65a, 65b each have the geometry of a rectangle 66 with two narrow sides 67 and two wide sides 68.

According to FIG. 3, the first conductor elements 60a are arranged in the radially inner partial space 59a and are electrically connected to one another for the connection to a common first phase of an electrical power source. In a corresponding manner, the second conductor elements 60b are arranged in the radially outer partial space 59b and are electrically connected to one another for the connection to a common second phase of the electrical power source. Furthermore, first conductor elements 60a are electrically insulated from the second conductor elements 60b by means of the phase insulation 58.

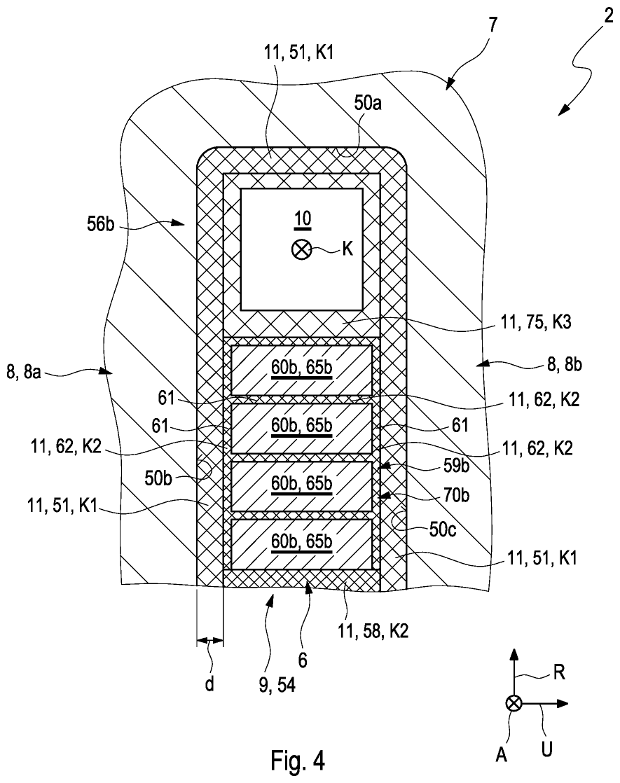

FIG. 4 shows a development of the example of FIG. 3. The example of FIG. 4 differs from that of FIG. 3 in that an additional cooling channel 10 is arranged in the region of a radially outer end portion 56b of the intermediate space 9 or of the stator groove 54, said end portion running opposite the radially inner end portion 56a with respect to the radial direction.

In the example of FIG. 4, the plastic 11—in an analogous manner to the first protective coating 75 of the cooling channel 10—forms a second protective coating 75 which is arranged in the intermediate space 9 and which bounds and thus encases the additional cooling channel 10. As FIG. 4 reveals, the additional cooling channel 10 arranged in the radially outer end portion 56b is arranged in the radially outer partial space 59b of the intermediate space 9 or of the stator groove 54, said partial space being formed by means of the phase insulation 58 formed by the plastic 11. In an analogous manner to the first protective coating 75, the second protective coating 75 can also bound the second cooling channel 10 radially on the inside and radially on the outside in the cross section perpendicular to the axial direction A. Similarly, the second protective coating 75 can surround, and thereby bound, the second cooling channel 10 in the circumferential direction U of the stator 2 in the cross section perpendicular to the axial direction A.

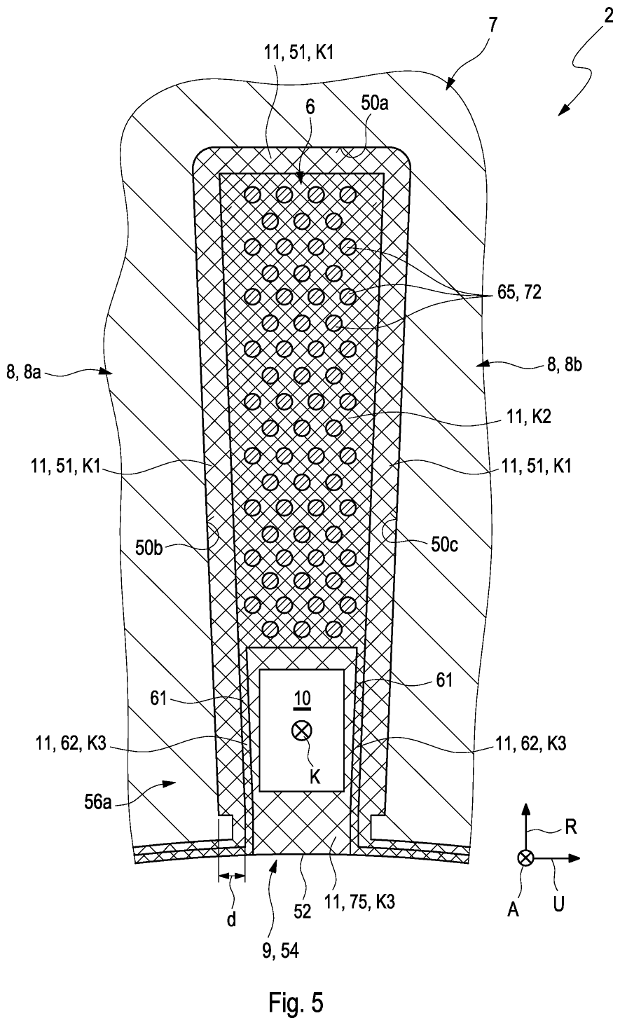

FIG. 5 shows a variant of the example of FIG. 3. In the example of FIG. 5, the plastic forms a plastics compound in which the stator winding 6 is embedded. In the example of FIG. 5, the conductor elements 65 of the stator winding 6 are formed by winding wires 72 which are part of a distributed winding.

The plastic 11 provided on the surface portions 50a, 50b, 50c of the stator teeth 8a, 8b can be formed by a, preferably electrically insulating, first plastics material Kl. The plastic 11 forming the phase insulation 58 can be formed by a second plastics material K2. The plastic 11 forming the first and second protective coating 75 can be formed by the second plastics material K2 or by a third plastics material K3 which differs therefrom. The second plastics material K2 is expediently electrically insulating or electrically conductive. The third plastics material K3 can also either be electrically insulating or electrically conductive. The first plastics material K1 can be a thermoplastic or a thermosetting plastic. The same is true of the second and the third plastics material K2, K3. In each case two or even all three plastics materials K1, K2, K3 can have identical heat conductivities. Alternatively thereto, the first and, alternatively or additionally, the second and, alternatively or additionally, the third plastics material K1, K2, K3 can have different heat conductivities. The first and, alternatively or additionally, the second and, alternatively or additionally, the third plastics material K1, K2, K3 can be identical materials. Alternatively thereto, the first and, alternatively or additionally, the second and, alternatively or additionally, the third plastics material K1, K2, K3 can be different materials.

Likewise expediently, the heat conductivity of the plastic 11, in particular of the first and, alternatively or additionally, of the second and, alternatively or additionally, of the third plastics material K1, K2, K3 is at least 0.5 W/mK, preferably at least 1 W/mK.

Reference is again made below to FIG. 1. Furthermore, according to FIG. 1, the stator 2 with the stator body 7 and the stator teeth 8 is arranged axially between a first and a second end plate 25a, 25b.

As FIG. 1 shows, part of the coolant distributor chamber 4 is arranged in the first end plate 25a and part of the coolant collector chamber 5 is arranged in the second end plate 25b. The coolant distributor chamber 4 and the coolant collector chamber 5 are therefore each partially formed by a cavity 41a, 41b provided in the plastic 11. The first cavity 41a is complemented here by a cavity 42a, formed in the first end plate 25a, to form the coolant distributor chamber 4. In a corresponding manner, the second cavity 41b is complemented by a cavity 42b, formed in the second end plate 25b, to form the coolant collector chamber 5. In the variant embodiment explained above, the plastic 11 therefore at least partially bounds the coolant distributor chamber 4 and the coolant collector chamber 5.

The first end plate 25a can furthermore contain a coolant feed 35 which fluidically connects the coolant distributor chamber 4 to a coolant inlet 33 provided on the outside, in particular, as illustrated in FIG. 1, on the circumferential side, of the first end plate 25a. A second end plate 25b can correspondingly contain a coolant drain 36 which fluidically connects the coolant collector chamber 5 to a coolant outlet 34 provided on the outside, in particular, as illustrated in FIG. 1, on the circumferential side, of the end plate 25b. This permits an arrangement of the coolant distributor chamber 4 and of the coolant collector chamber 5 in each case radially on the outside of the first and the second end portion 14a, 14b, respectively, of the relevant stator winding 6 and also along the axial direction A as an extension of said end portions 14a, 14b. The end portions 14a, 14b of the stator windings 6 that are particularly loaded thermally during the operation of the machine 1 are also particularly effectively cooled by means of this measure.

According to FIG. 1, the plastic 11 can also be arranged on an outer circumferential side 30 of the stator body 7 and can therefore form a plastics coating 11.1 on the outercircumferential side 30. The stator body 7 of the stator 2 that is typically formed from electrically conductive stator plates can therefore be electrically insulated from the surroundings. The provision of a separate housing for receiving the stator body 7 can therefore be omitted.

1. An electric machine, comprising:
a rotor rotatable about an axis of rotation which defines an axial direction and including a stator having electrically conductive stator windings; and
at least one cooling channel through which a coolant can flow to cool the stator windings,
wherein the stator has stator teeth which extend along the axial direction, are arranged at a distance from one another along a circumferential direction of the rotor, and carry the stator windings,
wherein the at least one cooling channel and the stator windings are arranged in at least one intermediate space formed between two adjacent stator teeth in the circumferential direction,
wherein a plastic for transmitting heat from the stator windings to the at least one cooling channel is arranged in the intermediate space.

2. The electric machine as claimed in claim 1, wherein
the plastic is arranged on surface portions of the two adjacent stator teeth bounding the intermediate space.

3. The electric machine as claimed in claim 1, wherein
the stator includes a stator body from which the stator teeth protrude radially inward, and wherein
the plastic is arranged on a surface portion of the stator body which bounds the intermediate space radially on the outside.

4. The electric machine as claimed in claim 3, wherein
the plastic forms an electrically insulating insulation layer which covers the surface portions of the two adjacent stator teeth.

5. The electric machine as claimed in claim 2,
wherein
the at least one cooling channel is arranged in a region of a radially inner end portion of the intermediate space.

6. The electric machine as claimed in claim 5,
wherein
the plastic forms at least one phase insulation which divides the intermediate space into a radially inner and a radially outer partial space, and wherein first conductor elements of the stator winding are arranged in the radially inner partial space and form a first phase winding, and second conductor elements of the stator winding are arranged in the radially outer partial space and form a second phase winding electrically insulated from the first phase winding.

7. The electric machine as claimed in claim 6,
wherein
the at least one phase insulation extends along the circumferential direction and connects two insulation layers arranged on the adjacent stator teeth.

8. The electric machine as claimed in claim 6,
wherein
the stator winding includes first conductor elements and second conductor elements,
the first conductor elements are arranged in the radially inner partial space and are electrically connected to one another for the connection to a common first phase of an electric power source, and wherein
the second conductor elements are arranged in the radially outer partial space and are electrically connected to one another for the connection to a common second phase of the electric power source.

9. The electric machine as claimed in claim 8,
wherein
the first and second conductor elements are surrounded by the plastic in a cross section perpendicular to the axial direction.

10. The electric machine as claimed in claim 9,
wherein
the first and second conductor elements are formed as winding bars made from an electrically conductive material.

11. The electric machine as claimed in claim 10,
wherein
the winding bars have a geometry of a right angle including two narrow sides and two wide sides in the cross section perpendicular to the axial direction.

12. The electric machine as claimed in claim 11,
wherein
the first conductor elements are electrically insulated from the second conductor elements via the phase insulation.

13. The electric machine as claimed in claim 8,
wherein
an additional cooling channel is arranged in a region of a radially outer end portion of the intermediate space.

14. The electric machine as claimed in claim 13,
wherein
the at least one cooling channel is arranged in the radially inner partial space formed via the phase insulation of plastic, and wherein
the additional cooling channel is arranged in the radially outer partial space formed via the phase insulation of plastic.

15. The electric machine as claimed in claim 14,
wherein
a gap is formed between two first conductor elements or between one first and second conductor element, and wherein
the plastic forms a gap filling with which the gap (63) is at least partially filled.

16. The electric machine as claimed in claim 1,
wherein
the plastic comprises a plastics compound in which the stator winding is embedded.

17. The electric machine as claimed in claim 1,
wherein
the intermediate space has geometry of a trapezoid or a rectangle in a cross section perpendicular to the axial direction.

18. The electric machine as claimed in claim 7,
wherein
the plastic provided on the surface portions of the stator teeth is formed by an electrically insulating first plastic material, and wherein
the plastic forming the at least one phase insulation is formed by a second plastic material, and wherein
the plastic forming a protective coating is formed by the second plastic material or by a third plastic material.

19. The electric machine as claimed in claim 18,
wherein
the second plastic material is configured to be electrically insulating or electrically conductive, and wherein
the third plastic material is configured to be electrically insulating or electrically conductive.

20. The electric machine as claimed in claim 19,
wherein
the first, second, and third plastic materials are a thermoplastic or a thermosetting plastic.

21. The electric machine as claimed in claim 20,
wherein
the first, second, and third materials have identical heat have different heat conductivities.

22. The electric machine as claimed in claim 21,
wherein
the first, the second, and third plastic materials are identical materials.

23. The electric machine as claimed in claim 1,
wherein
the stator is windings are a part of a distributed winding.

24. The electric machine as claimed in claim 22,
wherein
the heat conductivity of the first, second, and third plastic materials are at least 0.5 W/m K.

25. The electric machine as claimed in claim 1,
wherein
the intermediate space is formed to be substantially free of gaps or air inclusions.
